(19) United States
(12) Patent Application Publication
(10) Pub. No.: US 2010/0116792 A1
(43) Pub. Date: May 13, 2010

(54) METHOD OF JOINING PIECES OF METAL MATERIAL AND A WELDING DEVICE

(75) Inventor: Arne Boman, Trollhattan (SE)

Correspondence Address: WRB-IP LLP, 1217 KING STREET, ALEXANDRIA, VA, 22314, US

(73) Assignee: Volvo Aero Corporation, Trollhattan (SE)

(21) Appl. No.: 12/519,776

(22) PCT Filed: Dec. 18, 2006
(86) PCT No.: PCT/SE06/01438

§ 371 Date: Oct. 28, 2009

(51) Int. Cl. B23K 15/00; B23K 26/00

(52) U.S. Cl. 219/121.13; 219/121.64

(57) ABSTRACT

A welding device includes at least one beam-reflecting side element arranged so as to reflect at least a part of a high energy density beam towards a region in which a weld joint is to be generated in a piece of material, wherein the beam-reflecting side element protrudes from a surface of said piece of material.

### BACKGROUND AND SUMMARY

The present invention relates to a method of joining pieces of metal material by means of high energy density welding, comprising directing a high energy density beam to a surface of a piece of material into which a weld joint is to be generated.

The invention also relates to a welding device for the implementation of the method according to the invention.

In particular, the invention primarily relates to applications by which, by means of said weld joint, said piece of material is joined to a second piece of material provided on an opposite side of the first piece of material in relation to the surface thereof towards which said high energy density beam is directed.

Typically, the first piece of material is a sheet and that the second piece of material is a transverse element, the joint to be formed between said pieces of material being a T-joint. Preferably, said first piece of material is a first wall element of an engine wall, and said second piece of material is a second wall element of an engine wall. Such an engine wall may typically comprise inner wall, to which hot gas is admitted during engine operation, an outer wall, which is colder than the inner wall during engine operation, and at least two webs that connect the inner wall with the outer wall and delimit a cooling duct between said inner and outer walls, wherein said first piece of material comprises one of said inner and outer walls and the second piece of material comprises at least one of said webs. Alternatively, the method and device according to the invention maybe used for joining the ends of sheets that are bent so as to form the inner and outer walls of a cone-shaped engine wall as described.

In particular, the inventive method is conceived for the manufacturing of engine walls of a thrust nozzle wall of a rocket engine.

According to prior art, thrust nozzle walls of rocket engines are constructed as a sandwich construction consisting of an inner wall and an outer wall connected by webs that run in the lengthwise direction of the nozzle wall and delimit a plurality of ducts between the walls. The ducts are used as cooling ducts through which a cooling medium is permitted to flow. The cooling medium may comprise the engine fuel which is routed back to the combustion chamber after cooling, whereby the cooling is called regenerative cooling. On the other hand, the cooling medium might be a medium not primarily used for further purposes than cooling, whereby the cooling is called dump cooling. Also in this case the medium may comprise fuel, however not used for subsequent combustion.

Normally, steel is used a material of the thrust nozzle walls. However, in order to improve the thermal conductivity thereof, materials such as aluminum or copper have been proposed for at least parts of the nozzle wall. The usage of copper in the inner wall facing the hot gases facilitates a usage of the nozzle in higher heat fluxes than if steels are used on the inner side. This is preferable for high performance engines utilizing a high combustion chamber pressure thereby inflicting a high heat flux on the nozzle extension wall, particularly in the nozzle inlet part close to the throat of the combustion chamber. Another usage for high conductivity inner wall is for the expander cycle rocket engine where the heat absorbed by the nozzle cooling media, usually the engine fuel, is used to drive the engine turbines and thus it is of outmost importance to maximize the heat absorbed by the nozzle wall. The usage of copper instead of steel in the inner wall of an expander cycle rocket nozzle may increase the heat flux to the nozzle in the order of 10% by lowering the wall temperature compared to a steel nozzle.

According to prior art of producing the nozzle wall, the cooling channels thereof are cut out of a solid sheet thereby forming the inner wall and the webs of the nozzle wall. Subsequently, the outer wall of the nozzle wall is attached to the webs by means of soldering.

It might be conceived to use welding methods like electron beam welding or laser welding may for the connection of the outer wall to the webs, in order to accomplish a more joint of higher mechanical resistance than by soldering. However, high reflective materials like aluminum, beryllium, copper and alloys thereof tend to reflect the high energy beam to a significant degree. Thereby, the energy remaining for the generation of a melt in the material to be welded becomes to small, and, accordingly, the melt will be insufficient for a well-defined and proper weld joint to be generated.

Document U.S. Pat. No. 5,760,365 suggest the provision of a small, well-defined gap, preferably a v-shaped groove, between two adjacent parts that are to be joined by means of laser welding. The parts to be joined are in alignment with each other, thereby presenting generally coplanar upper surfaces. The laser beam is to be directed into said gap during the welding process, and the gap is to be filled with molten metal during said process. The design of the gap is such that the energy loss due to the reflections of the material of the parts to be joined is reduced. However, when, for example, a T-joint is to be generated by the application of a laser beam onto an through the upper part of said T, the formation of such a groove or gap in the upper part of said T might not be a favourable solution, from both technical and economical reasons.

It is desirable to present a method and a device by means of which two pieces of metal material may be joined by means of a high energy density welding method like laser welding, where the efficiency of the welding equipment is increased.

By a method and device according to aspects of the present invention, at least part of said high energy density beam can be reflected towards the welding region. The beam-reflecting side element may partly or, preferably, wholly encircle the region in which the weld joint is to be generated, in order to reflect back as large part as possible of the beam towards said region.

According to one embodiment the weld joint is generated along a line, and said beam-reflecting side element is provided alongside said line.

According to a further embodiment there are provided two beam-reflecting side elements on opposite sides of said line.

According to one embodiment said beam-reflecting side element is removably arranged at said surface. Thereby, the need of post-treatment of the weld area may be reduced. Alternatively said beam-reflecting side element is removably attached to said surface.

According to yet another one embodiment said beam-reflecting element is separate from said surface. Thereby, unwanted interaction between the beam-reflecting element and the piece of material to be welded may be prevented.

According to one embodiment said beam-reflecting element is moved along said surface in correspondence to the motion of the high energy density beam along said surface. It should be understood that said movement is relative, and that it might be achieved either by displacement of the beam-reflecting element or by the piece of material to be welded, or a combination thereof. A movable beam-reflecting element is advantageous in particular in the case when long weld joints are to be generated.

Preferably, the high energy density beam is a laser beam.

According to one embodiment said piece of material comprises a material with an elevated ability of reflecting said high energy density beam. The material may be aluminum, beryllium, copper and alloys thereof. In particular, said piece of material comprises copper as a main constituent.

According to one embodiment a second piece of material, to which said first piece of material is to be joined by means of said weld joint, is made of the same material as said first piece of material.

According to one embodiment it is preferred that, by means of said weld joint, said piece of material is joined to a further piece of material provided on an opposite side of the first piece of material in relation to the surface thereof towards which said high energy density beam is directed. According to yet another embodiment the first piece of material is a sheet and that the second piece of material is a transverse element, the joint to be formed between said pieces of material being a T-joint. According to one embodiment said first piece of material is a first wall element of an engine wall, and that said second piece of material is a second wall element of an engine wall.

According to one embodiment said engine wall comprises inner wall, to which hot gas is admitted during engine operation, an outer wall, which is colder than the inner wall during engine operation, and at least two webs that connect the inner wall with the outer wall and delimit a cooling duct between said inner and outer walls, wherein said first piece of material comprises one of said inner and outer walls and the second piece of material comprises at least one of said webs. Preferably, the engine wall is a thrust nozzle wall of a rocket engine.

According to an alternative embodiment said surface of a piece of material is a surface at which two opposite ends of one or more sheets are to be joined in alignment with each other along a line by means of welding.

According to one embodiment, said piece of material comprises a sheet formed into a generally cylindrical part of a thrust nozzle wall of a rocket engine, and that the method is used for the joining of two opposite ends of said sheet.

According to another aspect of the present invention, a welding device comprises at least one beam-reflecting side element arranged so as to reflect at least a part of said high energy density beam towards a region in which a weld joint is to be generated in a piece of material, wherein said beam-reflecting side element protrudes from a surface of said piece of material. The beam-reflecting side element may partly or fully encircle the region in which the weld is to be generated. The inner surface of said element may, alone or in combination with possible further beam-reflecting elements, form a funnel or sector of a funnel, narrowing in a direction towards said weld region.

According to one embodiment said beam-reflecting side element is provided alongside a line along which a weld joint is to be generated.

According to one embodiment there are provided two beam-reflecting side elements on opposite sides of said line. In other words, there are provided two opposite side elements with a spacing between each other, in which spacing a high energy density beam is to be directed towards a weld region.

According to one embodiment said beam-reflecting side is removably arranged at said surface. Alternatively, said beam-reflecting side element (9, 10) is removably attached to said surface.

As a further alternative, said beam reflecting element is separate from said surface.

According to one embodiment said beam-reflecting element is arranged so as to be moved along said surface in correspondence to a motion of the high energy density beam emitting means along said surface.

According to yet another embodiment said beam-reflecting element comprises means for the cooling thereof.

Preferably, said means comprises at least one cooling channel extending through the body of said beam-reflecting element. However, other solutions, such as external cooling elements, are also possible.

According to one embodiment said beam-reflecting side element presents an inner, reflecting surface that forms an obtuse angle a of more than 90° and less than 135° in relation to the surface of the adjacent piece of material towards which the high energy density beam emitting element is directed.

According to a further embodiment that it comprises a top part arranged on top of said beam-reflecting element and acting as a further beam-reflecting element.

Preferably, said top part comprises means for the cooling thereof. According to one embodiment said means comprises at least one cooling channel extending through the body of said top part.

The invention also includes the use of at least one beam-reflecting cross-element extending crosswise to said beam-reflecting element. Preferably two opposed such cross-elements are used in combination with two opposed beam-reflecting elements, such that rectangular or square-shaped funnel is generated for the reflection of parts of said beam towards the weld region. As indicated earlier, such a funnel should narrow in a direction towards the weld region.

Further features and advantages of the present invention will be presented in the following detailed description.

### BRIEF DESCRIPTION OF THE DRAWINGS

Preferred embodiments of the present invention will now be described by way of example, with reference to the annexed drawings, on which:

FIG. 1 shows a cross section of a nozzle provided with an engine wall according to the invention.

FIG. 2 is an enlargement of a segment of the engine wall according to FIG. 1,

FIG. 3 is a schematic representation of a cross section of a part of an engine wall to be produced by the method of the invention,

FIG. 4 is a view corresponding to FIG. 3, showing the implementation of an embodiment of the invention, during manufacture of the engine wall,

FIG. 5 is a view corresponding to FIG. 3, showing a second embodiment of the invention, and

FIG. 6 is a view showing the implementation of the invention for the welding of aligned sheet ends.

### DETAILED DESCRIPTION

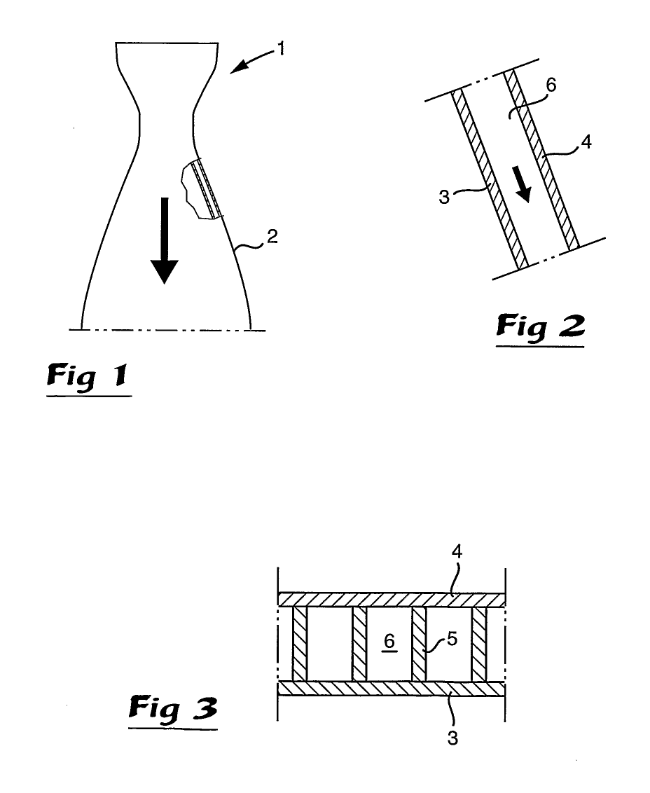

FIGS. 1 and 2 are schematic representations of the thrust nozzle 1 of a rocket engine. The nozzle 1 comprises and is defined by a generally cone-shaped engine wall 2. The engine wall 2 is provided with an inner wall 3, preferably with a thickness of 0.15-2 mm, and an outer wall 4, interconnected by a plurality of webs 5, as shown in FIG. 3. In the space between the inner wall 3 and the outer wall 4 there are ducts 6 that are used for cooling purposes, each duct 6 being delimited by two adjacent webs 5, the inner wall 3 and the outer wall 4. During operation of the engine a cooling medium, preferably the fuel or part of the fuel of the engine, is permitted to flow through the ducts 6 for the purpose of cooling the engine wall 2. This technique applies to satellite launchers and space planes, and also in satellite thrusters, nuclear reactors and high efficiency boilers, and it can also be applied to heat shields or to the nose cones of vehicles travelling at very high speed.

The webs 5 are elongated, extend mainly in the longitudinal direction of the nozzle 1, and act as intermediate walls between adjacent ducts 6. Preferably, the thickness of the webs 5 is constant along their longitudinal direction. Accordingly, since the nozzle 1 is cone-shaped, the width of the ducts 6 increases in the longitudinal direction, i.e. in the flame propagation direction of the engine to which the nozzle is associated.

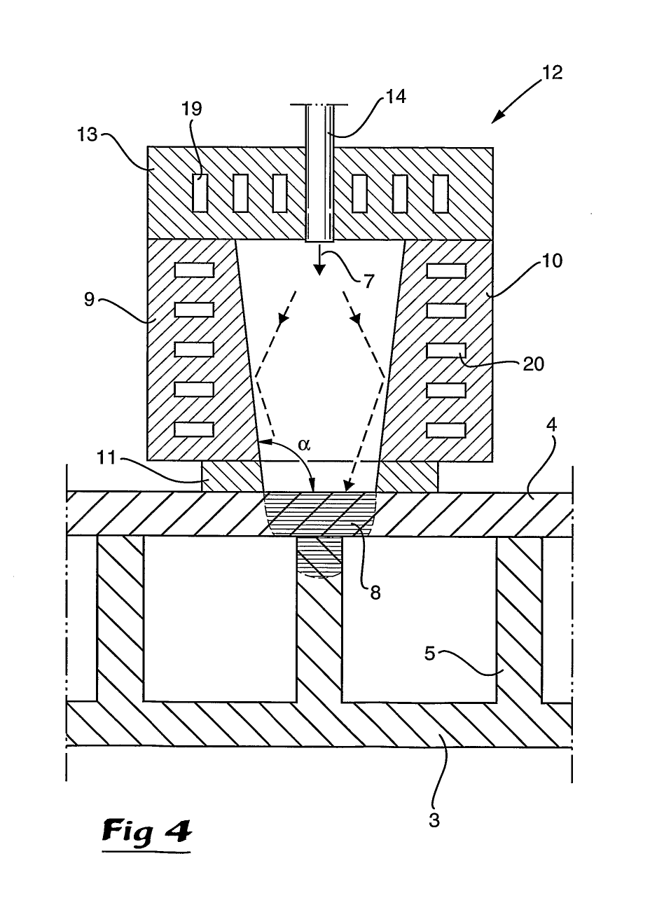

During manufacture of the engine wall 2, the ducts 6 are cut out of a sheet material, whereby the inner wall 3 and the webs 5 are formed. Alternatively, the webs 5 may be formed by means of any deposition method, by which depositions of web material attaining the shape of said webs 5 are deposited onto a sheet forming the inner wall 3. Subsequently to the generation of the webs 5, a sheet forming the outer wall 4 is applied onto the webs 5 on the opposite side of the inner wall 3. The outer wall 4 is attached to the ends of the webs 5 by means of high energy density welding, preferably by means of laser welding. Thereby, as shown in FIG. 4, a high energy density beam 7 is directed towards the upper surface of the outer wall 3 opposite the one directed towards the webs 5. The high energy density beam 7 is supposed to melt the outer wall 4 down to a region in which it is in contact with the underlying web 5, and also to melt the material of the latter sufficiently to generate a requested weld joint 8 between the outer wall 4 and the web 5. The laser beam 7 is moved along a line corresponding to the longitudinal extension line of the web 5. Thereby, an elongated weld joint is generated.

FIG. 4 shows how the method of the invention may be implemented. A specific device for the implementation of the method is used. Said device comprises a welding head 12 arranged so as to focus a high energy density beam towards the area in which the weld joint is to be generated, or at least to prevent parts of the beam from being reflected away from said area. Accordingly, on opposite sides of the region in which the laser beam 7 hits the upper surface of the outer wall 5, there are provided beam-reflecting elements 9, 10, adapted to prevent reflected laser light from simply being reflected away from the laser weld region, but instead to reflect them back towards the weld region, in order to prevent losses of energy due to such reflection. The beam-reflecting elements 9,10 are provided at opposite sides of a line along which the welding is to be performed, i.e. the extension line of the web 5 to be welded. The inner, reflecting surface of the beam-reflecting elements 9,10 may, preferably, form an angle α of more than 90°, but, preferably, less than 135° in relation to the surface of the adjacent piece of material towards which the weld beam is directed, in this case the outer wall 4. Further to the beam-reflecting side elements 9, 10, the welding head 12 may also comprise cross elements, not shown, extending crosswise to the side elements 9, 10 and arranged so as to form a housing together with the side-elements 9, 10 in order to further prevent parts of the beam 7 from being reflected away from the weld region between the side elements 9, 10. The inner, reflecting surface of any such cross element, that is turned towards the welding region may also have an inclination angle of more than 90° and less than 135° in relation to the surface of the piece of material 4 towards which the weld beam is directed. Accordingly, a space that narrows in the propagation direction of the high energy density beam towards the weld region is delimited by the beam-reflecting side elements 9, 10 and any possible further cross element. The beam-reflecting side elements 9,10 and any possible cross element may also be shaped so as to form a conical space, with generally circular cross section, that narrows in the propagation direction of the high energy density beam 7 during operation. It is conceivable that the beam-reflecting elements and any cross elements may be defined by one single element, and not necessarily by a number of discrete parts interconnected into a single unit. The sides of the beam-reflecting elements 9, 10 and any possible cross element can be given a non-linear shape which acts as a mirror shaped in order to more accurately reflect the laser light into the weld. This non-linear shape may be designed by methods used for optics where a focal point is sought for a given incoming light.

Further to the beam-reflecting elements 9, 10, and any possible cross element, the welding head 12 may also comprise a top part 13 provided on top of the beam-reflecting elements 9, 10, thereby defining a hat, for the purpose of reflecting back to the weld region parts of the beam 7 that may have been reflected back from said region or the side elements 9, 10. A through hole may be provided in the top part 13 for the introduction of a high energy density beam 7 or an element 14 for emitting such a beam through said top part 13. The top part 13 maybe made of material with elevated heat conductivity, such as copper. It may also be actively cooled, for example by means of a cooling medium, such as water or nitrogen, that is permitted to exchange heat with said top part 13. For example, the top part 13 may comprise channels provided therein for the conduction of a cooling medium. In this context it should be mentioned that, depending on the specific operation conditions, there might be provided active cooling also of the beam-reflecting side elements 9, 10 as well as any possible further cross element. Also in this case there may be provided cooling channels in said elements in order to promote such cooling.

The welding head 12 may also comprise at least one sealing element 11 provided between each beam-reflecting side element 9, 10 and the upper surface of the adjacent piece of material to be welded, in this case the wall 4. The sealing element 11 may be a metallic strip and of smaller width than the beam-reflecting element 9, 10 to which it is attached and, possibly, of another material than said beam-reflecting element 9, 10, said material then being optimised with regard to the specific function of the sealing element 11. The sealing element 11 may be provided so as to be connected to the beam-reflecting elements 9, 10 and to be displaced through sliding along the adjacent piece of material 4 to be welded. Alternatively, a gap is permitted between the sealing element 11 and said piece of material, in order to avoid unwanted interaction between the sealing element and the piece of material 4 to be welded, or attachment of the sealing element 11 to the piece of material 4 due to heat conduction during the welding process. According to a further alternative, said sealing elements 11 may be elongated strips that are attached to the piece of material to be welded, while the remaining part of the welding head 12, primarily its beam-reflecting side elements 9, 10, may be slidingly and displaceably arranged on top of said sealing elements. Such an embodiment will, though, require a removal of the sealing elements 11 from the adjacent piece of material 4 to be welded after completion of the welding procedure, possibly by milling or turning.

Preferably, the beam reflecting elements 9, 10 are made of the same material as the piece of material 4 to be welded, here the nozzle wall 4 (copper in case of copper outside wall 4 and aluminum in case of aluminum outside wall 4). The height of the beam reflecting elements 9, 10 are >1 mm and <20 mm. The width of each beam-reflecting side element 9, 10 closest to the piece of material to be welded is >1 mm.

The width of the web 5 to be welded is typically 0.5-2 mm. The distance between the opposite beam-reflecting side elements 9, 10 should correspond to said width in order to promote the generation of a weld joint of a desired width

For the case in which the high energy density beam 7 is directed with an inclination angle different from 90° with regard to the surface which it is to hit, the welding head 12 may be tilted with respect to the outer surface of the piece of material 4 to be welded in order to avoid back-scatter into the welding device.

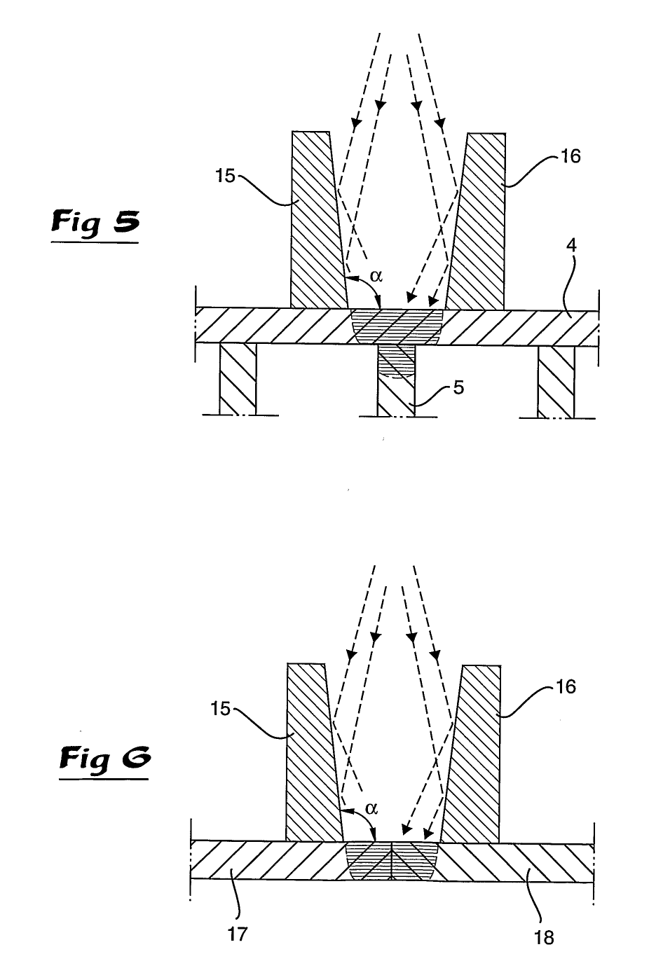

FIG. 5 shows an alternative embodiment of an arrangement used for the implementation of the inventive method. The arrangement comprises two opposite beam-reflecting elements 15, 16 pre-arranged at opposite sides of a line along which a weld joint is to be generated as suggested by the invention. The beam-reflecting elements are attached to the underlying piece of material 4, for example by means of spot welding or the like. Each of the beam-reflecting elements 15, 16 has an inclined surface towards said welding line, such that the gap between said surfaces narrows in the conceived beam-propagation direction towards the underlying piece of material, i.e. the outer wall 4 in this case. The inclination angle a, as well as the specific shape of the reflecting surface of the beam-reflecting elements 15, 16 may correspond to those of the beam-reflecting elements 9, 10 of the embodiment of FIG. 4. The height of each of the beam-reflecting elements 15, 16 may be as for the corresponding elements 9, 10 of the embodiment of FIG. 4. The width of each beam-reflecting side element 15, 16 closest to the piece of material to be welded should be >1 mm.

Also the embodiment shown in FIG. 5 may be provided with a top part corresponding to the top part 13 shown in FIG. 4. Such a top part may either be non-movably or movably arranged on top of the beam reflecting elements 15, 16. In the former case it may be provided with a slot through which a high energy density beam emitting means 14 is permitted to introduce the beam 7, while in the latter case it might be provided with an opening only large enough for said introduction, said opening being arranged so as to follow the motion of the high energy density beam emitting means 14 along the surface of the piece of material to be welded.

FIG. 6 shows how the arrangement of the invention as shown in FIG. 5 may be used for the purpose of joining two aligned pieces of material 17, 18, for example two sheets or the two ends of one sheet of material that are to be joined in alignment with each other along a line. Also the embodiment shown in FIG. 4 may be used for such a purpose. Preferably, the ends 17, 18 are the ends of a sheet forming the outer wall 4 or the inner wall 3 of the engine wall 2.

Preferably, in the embodiments of FIG. 4 as well as FIG. 5 and FIG. 6, the high energy density beam is a laser beam. The laser light used is preferably a YAG laser but also a fiber optic laser is possible. The effect of the laser may be, but is not limited to, 4 kW. The operation of the laser may be a pulsed mode. The travel speed is typically, but not limited to, 0.1 to 2 m/min. Laser light wave length could be 1064 nm but preferably 532 nm since light at 532 nm wave length is absorbed better by copper and aluminum than more commonly used 1064 nm.

In the embodiments shown in FIGS. 4 and 5 the width of the web 5 to be welded is typically 0.5-2 mm. The distance between the opposite beam-reflecting side elements 9, 10 or 15, 16 should correspond to said width in order to promote the generation of a weld joint of a desired width. However, in the embodiment shown in FIG. 6, the distance between the beam-reflecting side elements 15, 16 maybe reduced in comparison to the previous embodiments, since the weld joint is to be delimited to contact plane between the pieces of material 17, 18 that extends in the propagation direction of the high energy density beam 7, while in the previous embodiments (see FIGS. 4 and 5) such a contact plane extends perpendicularly to the propagation direction of the beam in question.

Further to the features already stated for the different embodiments of the invention, it might be preferred to use a welding gas that is supplied into the weld zone in order to increase weld joint quality.

1. A method of joining pieces of metal material by high energy density welding, comprising directing a high energy density beam to a surface of a piece of material at which a weld joint is to be generated, characterised in providing at least one side element adjacent a region in which the weld joint is to he generated, so that it protrudes from the surface and is able to reflect at least a part of the high energy density beam towards the region, wherein the beam-reflecting side element presents an inner, reflecting surface that form an obtuse angle [α] of more than 90° and less than 135° in relation to the surface of the adjacent piece of material towards which the high energy density beam is directed.

2. A method according to claim 1, comprising generating the weld joint along a line and providing the beam-reflecting side element alongside the line.

3. A method according to claim 1, comprising providing two beam reflecting side elements on opposite sides of the region.

4. A method according to claim 1, comprising removably arranging the beam-reflecting side element at the surface.

5. A method according to claim 1, comprising removably attaching the beam-reflecting side element to the surface.

6. A method according to claim 1, wherein the beam reflecting element is separate from the surface.

7. A method according to claim 6, comprising moving the beam-reflecting element along the surface in correspondence to the motion of the high energy density beam along the surface.

8. A method according to claim 1, wherein the high energy density beam is a laser beam.

9. A method according to claim 1, wherein the piece of material comprises a material with an elevated ability of reflecting the high energy density beam.

10. A method according to claim 9, wherein the piece of material comprises copper as a main constituent.

11. A method according to claim 9, wherein a second piece of material, to which the first piece of material is to be joined by the weld joint, is made of the same material as the first piece of material.

12. A method according to claim 1, wherein, by the weld joint, the piece of material is joined to a further piece of material provided on an opposite side of the first piece of material in relation to the surface thereof towards which the high energy density beam is directed.

13. A method according to claim 12, wherein the first piece of material is a sheet and that the second piece of material is a transverse element, the joint to be formed between the pieces of material being a T-joint.

14. A method according to claim 12, wherein the first piece of material is a first wall element of an engine wall, and that the second piece of material is a second wall element of an engine wall.

15. A method according to 14, wherein the engine wall comprises an inner wall, to which hot gas is admitted during engine operation, an outer wall, which is colder than the inner wall during engine operation, and at least two webs that connect the inner wall with the outer wall and delimit a cooling duct between the inner and outer walls, wherein the first piece of material comprises one of the inner and outer walls and the second piece of material comprises at least one of the webs.

16. A method according to claim 15, wherein the engine wall is a thrust nozzle wall of a rocket engine.

17. A method according to claim 1, wherein the surface of a piece of material is a surface at which two opposite ends of one or more sheets are to he joined in alignment with each other along a line by welding.

18. A method according to claim 17, wherein the piece of material comprises a sheet fanned into a generally cylindrical part of a thrust nozzle wall of a rocket engine, and that the method is used for the joining of two opposite ends of the sheet.

19. A welding device comprising at least one beam-reflecting side element arranged so as to reflect at least a part of a high energy density beam towards a region in which a weld joint is to be generated in a piece of material, wherein the beam-reflecting side element is configured to protrude from a surface of the piece of material, wherein the beam-reflecting side element presents an inner, reflecting surface that form an obtuse angle [α] of more than 90° and less than 135° in relation to the surface of the adjacent piece of material towards which the high energy density beam is directed.

20. A welding device according to claim 19, comprising two opposite beam-reflecting side elements.

21. A welding device according to claim 19, wherein the beam-reflecting side element is configured to be removably arranged at the surface.

22. A welding device according to claim 19, wherein the beam-reflecting side element is configured to be removably attached to the surface.

23. A welding device according to claim 19, wherein the beam reflecting element is separate from the surface.

24. A welding device according to claim 19, comprising a high energy density beam emitting element.

25. A welding device according to claims 24, wherein the beam-reflecting element is configured so as to be moved along the surface in correspondence to a motion of the high energy density beam emitting means along the surface.

26. A welding device according to claim 19, wherein the beam-reflecting element comprises means for the cooling thereof.

27. A welding device according to claim 26, wherein the means comprises at least one cooling channel extending through the body of the beam-reflecting element.

28. A welding device according to claim 19, comprising a top part arranged on top of the beam-reflecting element and acting as a further beam-reflecting element.

29. A welding device according to claim 28, wherein the top part comprises means for the cooling thereof.

30. A welding device according to claim 29, wherein the means comprises at least one cooling channel extending through the body of the top part.

31. A welding device according to claim 19, comprising at least one beam-reflecting cross-element extending crosswise to the beam-reflecting element.
